(19) United States
(12) Patent Application Publication
(10) Pub. No.: US 2017/0114237 A1
(43) Pub. Date: Apr. 27, 2017

(54) AQUEOUS INK FOR INKJET USE

(71) Applicant: CANON KABUSHIKI KAISHA, Tokyo (JP)

(72) Inventors: Taketoshi OKUBO, Asaka-shi (JP); Kenichi IIDA, Kawasaki-shi (JP)

(21) Appl. No.: 15/301,344

(22) PCT Filed: Mar. 23, 2015
(86) PCT No.: PCT/JP2015/059824

§ 371 Date: Sep. 30, 2016

(30) Foreign Application Priority Data
Apr. 4, 2014 (JP) 2014-077756
Mar. 4, 2015 (JP) 2015-042691

(51) Int. Cl. C09D 11/326; B41J 2/01; C09D 11/322

(52) U.S. Cl. CPC C09D 11/326; C09D 11/322; B41J 2/01

(57) ABSTRACT

An aqueous ink for inkjet use contains particles of a compound represented by general formula (I) below and a dispersant that disperses the particles:

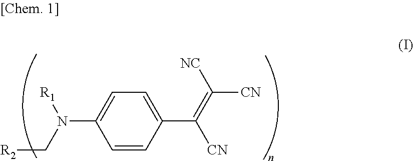

wherein R₁ represents an aromatic ring; R₂ represents a hydrogen atom, an alkyl group, or a benzene ring; when R₂ is a hydrogen atom or an alkyl group, n is 1; and when R₂ is a benzene ring, n is an integer of any one of 1 to 3.

### TECHNICAL FIELD

The present invention relates to an aqueous ink for inkjet use.

### BACKGROUND ART

Hitherto, in order to produce images having metallic luster, such as golden color, on recording materials, such as advertising prints and photographs, offset printing, gravure printing, screen printing, and the like, which use an ink containing a metal pigment, such as an aluminum pigment or a brass pigment, have been employed. In recent years, with the development of inkjet recording methods, there has been a demand for development of an aqueous ink capable of recording an image having metallic luster by an inkjet recording method.

As an ink for recording an image having metallic luster, such as golden color, by an inkjet recording method, PTL 1, PTL 2, and PTL 3 each propose an ink which contains metal particles, such as gold, silver, or aluminum particles. Furthermore, PTL 4 reports an organic compound having metallic luster, which is used as a colorant.

### CITATION LIST

### Patent Literature

PTL 1 Japanese Patent Laid-Open No. 2004-067931

PTL 2 Japanese Patent Laid-Open No. 2009-269935

PTL 3 Japanese Patent Laid-Open No. 2010-121141

PTL 4 Japanese Patent Laid-Open No. 2006-249259

### SUMMARY OF INVENTION

### Solution to Problem

The present invention provides an aqueous ink for inkjet use which contains particles of a compound represented by general formula (I) below and a dispersant that disperses the particles.

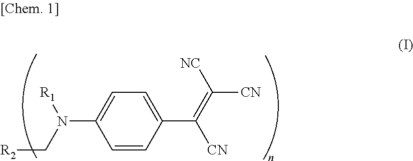

wherein R₁ represents an aromatic ring; R₂ represents a hydrogen atom, an alkyl group, or a benzene ring; when R₂ is a hydrogen atom or an alkyl group, n is 1; and when R₂ is a benzene ring, n is an integer of any one of 1 to 3.

Further features of the present invention will become apparent from the following description of exemplary embodiments.

### DESCRIPTION OF EMBODIMENTS

In the inks proposed in PTL 1, PTL 2, and PTL 3, metal particles are likely to form a sediment because of high specific gravity, which presents a problem in terms of long-term storage stability. Furthermore, since metal particles, such as aluminum or silver particles, that are likely to discolor in air or water are used as a pigment, discoloration is likely to occur after printing, and image stability may be insufficient in some cases.

Furthermore, PTL 4 does not give consideration to preparation of a dispersion that can be ejected by an inkjet method, and moreover, PTL 4 does not describe that a film composed of the organic compound used as a colorant produces a golden color.

The present invention provides an aqueous ink for inkjet use which can record golden color images and which has excellent long-term storage stability.

### Aqueous Ink for Inkjet Use

Exemplary embodiments of the present invention will be described below. However, the present invention is not limited to the embodiments. An aqueous ink for inkjet use (hereinafter also referred to as the “ink”) contains particles of a compound represented by general formula (I) below and a dispersant that disperses the particles. The aqueous ink for inkjet use according to the present invention will be described in detail below.

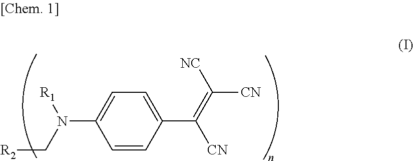

wherein R₁ represents an aromatic ring; R₂ represents a hydrogen atom, an alkyl group, or a benzene ring; when R₂ is a hydrogen atom or an alkyl group, n is 1; and when R₂ is a benzene ring, n is an integer of any one of 1 to 3.

### Compound Represented by General Formula (I)

The ink of the present invention contains particles of a compound represented by general formula (I). Compounds represented by general formula (I) are characterized by having a phenyl(4-tricyanovinylphenyl)amino group. This substituent acts as a chromophore, and the compound represented by general formula (I) has a maximum absorption wavelength at around 500 nm. Therefore, a solution obtained by dissolving such a compound in an organic solvent produces a red color. The present inventors have found that a film formed by an inkjet using an ink containing particles of such a compound produces a golden color.

The mechanism in which the film containing particles of such a compound produces a golden color is presumed to be as follows, although it is only a presumption. Firstly, in order for an image to have a golden color, it is necessary for surface-reflected light to have a high reflectance in the wavelength range of 500 to 700 nm. The film containing particles of such a compound has high absorption at around 500 nm. Therefore, as in the bronze phenomenon observed in a phthalocyanine-based color material (i.e., the phenomenon in which a film containing a copper phthalocyanine-based color material having a maximum absorption wavelength of 600 to 700 nm emits red surface-reflected light having the same wavelength range as the absorption wavelength range), strong surface-reflected light is emitted at a wavelength in the range of around 500 nm. Furthermore, since the phenyl(4-tricyanovinylphenyl)amino group has a molecular structure having high planarity, particles in which molecules are closely packed due to the intermolecular stacking effect are likely to be formed. Accordingly, the film containing particles of the compound represented by general formula (I) has a high refractive index in the wavelength range of around 600 to 700 nm, and therefore has a property of emitting strong surface-reflected light in the same wavelength range. The combination of these effects is believed to make it possible to form a film having a high reflectance in the wavelength range of 500 to 700 nm, resulting in formation of a film with an apparent golden color.

The term “aromatic ring” used herein refers to a single ring having aromaticity or a condensed ring in which a plurality of rings having aromaticity are condensed. Specific examples of the aromatic ring include a benzene ring, a naphthalene ring, an anthracene ring, and an azulene ring. In particular, a benzene ring can be used. The aromatic ring can be unsubstituted, or may be substituted with a substituent. In this case, specific examples of the substituent include a halogen atom and an alkyl group.

Furthermore, examples of the alkyl group that can be used include straight-chain or branched-chain alkyl groups having 1 to 10 carbon atoms. Specific examples of such alkyl groups include a methyl group, an ethyl group, a n-propyl group, an isopropyl group, a n-butyl group, an isobutyl group, a tert-butyl group, a sec-butyl group, a n-pentyl group, a neopentyl group, a n-hexyl group, an isohexyl group, and a 3-methylpentyl group. Specific examples of the halogen atom include a fluorine atom, a chlorine atom, a bromine atom, and an iodine atom.

Furthermore, when R₂ is a hydrogen atom or an alkyl group, n is 1. That is, there is one phenyl(4-tricyanovinylphenyl)amino group in a molecule. When R₂ is a benzene ring, n is an integer of any one of 1 to 3. That is, there are one to three phenyl(4-tricyanovinylphenyl)amino groups in a molecule. In order to obtain a golden color image, it is better that phenyl(4-tricyanovinylphenyl)amino groups acting as a chromophore be present at positions that are spatially close to each other as much as possible. Accordingly, a molecular structure in which a plurality of phenyl(4-tricyanovinylphenyl)amino groups are present in a molecule is advantageous in terms of golden color development. Therefore, R₂ is preferably a benzene ring, and n is preferably 2 or 3, and more preferably 2.

Furthermore, in particular, the compound represented by general formula (I) can be a compound represented by general formula (II) below.

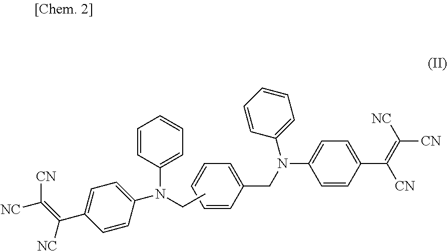

Specific examples of the compound represented by general formula (I) include compounds 1 to 7 represented by formulae (1) to (7) below, respectively. However, the compound constituting the particles contained in the ink of the present invention is not limited to the specific examples shown below.

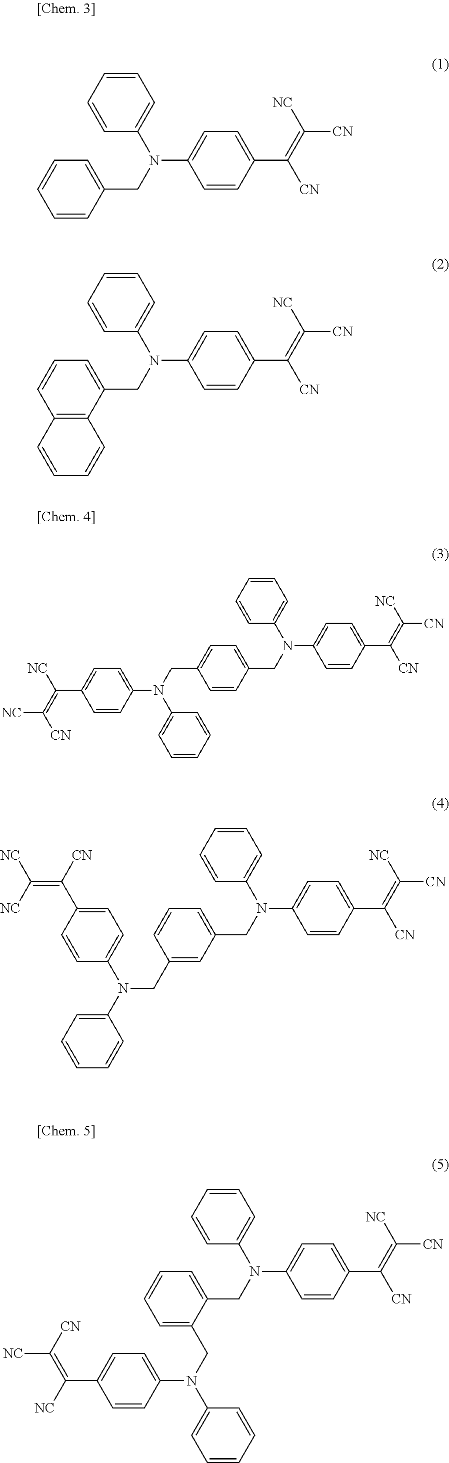

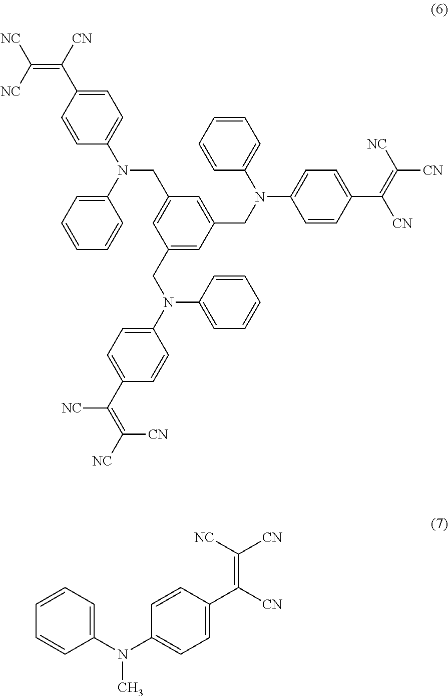

The content of the compound represented by general formula (I) in the ink is preferably 0.5% by mass or more, more preferably 1.0% by mass or more, and particularly preferably 1.5% by mass or more, relative to the total amount of the ink. When the content of the compound represented by general formula (I) is less than 0.5% by mass, the compound concentration in a film to be formed decreases, and therefore, in some cases, it may not be possible to record an image having satisfactory metallic luster. Furthermore, the content of the compound represented by general formula (I) in the ink is preferably 10.0% by mass or less, and more preferably 5.0% by mass or less. When the content of the compound represented by general formula (I) is more than 10.0% by mass, in some cases, it may not be possible to obtain satisfactory ejection stability of the ink.

### Particles of Compound Represented by General Formula (I)

The particles contained in the ink of the present invention are composed of a compound represented by general formula (I). Furthermore, the particles are dispersed in the ink by a dispersant which will be described later. The average particle size of the particles dispersed in the ink is preferably 5 nm or more, and more preferably 10 nm or more. Furthermore, the average particle size of the particles dispersed in the ink is preferably 1,000 nm or less, more preferably 500 nm or less, and particularly preferably 200 nm or less. When the average particle size of the particles dispersed in the ink is out of the range described above, in some cases, it may not be possible to obtain satisfactory ejection stability of the ink from an inkjet head.

The average particle size of particles in the present invention means the volume-average particle size at a cumulative value of 50% in the particle size distribution measured using a dynamic light scattering particle size/particle size distribution measuring apparatus utilizing scattering of laser beams. As the dynamic light scattering particle size/particle size distribution measuring apparatus, for example, trade name “FPAR-1000” (manufactured by Otsuka Electronics Co., Ltd., cumulant method analysis), “Nanotrac UPA 150EX” (manufactured by Nikkiso Co., Ltd.), or the like can be used.

### Dispersant

The ink of the present invention contains a dispersant capable of stably dispersing the particles of a compound represented by general formula (I) in the ink. As the dispersant, a low-molecular-weight dispersant or a resin dispersant (high-molecular-weight dispersant) can be used. These dispersants may be used in combination.

The low-molecular-weight dispersant means a surfactant having hydrophilic and hydrophobic portions and having a molecular weight of less than 1,000. Examples of the hydrophilic portion include an anionic group, a cationic group, and a nonionic group. Furthermore, an amphoteric (betaine type) surfactant having an anionic group and a cationic group can also be used.

The anionic group is a group that can be negatively charged. Specific examples of the anionic group include a carboxyl group, a sulfonate group, a sulfate group, a phosphonate group, and a phosphate group. The cationic group is a group that can be positively charged. Specific examples of the cationic group include an ammonium group and a pyridinium group. Specific examples of the nonionic group include polyethylene oxide and a sugar unit. The hydrophilic portion of the low-molecular-weight dispersant (surfactant) can be an anionic group, and more particularly a sulfonate or carboxyl group.

The hydrophobic portion of the low-molecular-weight dispersant (surfactant) is, for example, composed of a hydrocarbon, fluorocarbon, silicone, or the like. In particular, the hydrophobic portion of the low-molecular-weight dispersant can be composed of a hydrocarbon, preferably a hydrocarbon having 2 to 24 carbon atoms, and particularly preferably a hydrocarbon having 6 to 20 carbon atoms. The hydrophobic portion of the low-molecular-weight dispersant may have a straight-chain structure or a branched-chain structure, and furthermore, may have a single chain or multiple chains.

Specific examples of the low-molecular-weight dispersant having an anionic group (anionic surfactant) include a N-acyl-N-methyltaurine salt, a fatty acid salt, an alkyl sulfate ester salt, an alkylbenzene sulfonate, an alkylnaphthalene sulfonate, a dialkylsulfosuccinate, an alkyl phosphate ester salt, a naphthalenesulfonic acid formalin condensate, and polyoxyethylene alkyl sulfate ester salt. As the cation for forming a salt, alkali metal cations can be used. These anionic surfactants can be used alone or in combination of two or more. Specific examples of the low-molecular-weight dispersant having a cationic group (cationic surfactant) include a quaternary ammonium salt, an alkoxylated polyamine, an aliphatic amine polyglycol ether, an aliphatic amine, a diamine and a polyamine derived from an aliphatic amine and an aliphatic alcohol, imidazoline derived from a fatty acid, and salts of these substances.

Specific examples of the nonionic low-molecular-weight dispersant (nonionic surfactant) include a polyoxyethylene alkyl ether, a polyoxyethylene alkylaryl ether, a polyoxyethylene fatty acid ester, a sorbitan fatty acid ester, a polyoxyethylene sorbitan fatty acid ester, a polyoxyethylene alkylamine, and a glycerol fatty acid ester. In particular, a polyoxyethylene alkylaryl ether can be used. These nonionic surfactants can be used alone or in combination of two or more.

The resin dispersant means a dispersant having a weight-average molecular weight of 1,000 or more. As the resin dispersant, a resin dispersant having an anionic group can be suitably used. Specific examples of the resin dispersant include a styrene-acrylic acid copolymer, a styrene-acrylic acid-acrylic acid alkyl ester copolymer, a styrene-maleic acid copolymer, a styrene-maleic acid-acrylic acid alkyl ester copolymer, a styrene-methacrylic acid copolymer, a styrene-methacrylic acid-acrylic acid alkyl ester copolymer, a styrene-maleic acid half ester copolymer, a vinylnaphthalene-acrylic acid copolymer, a vinylnaphthalene-maleic acid copolymer, a styrene-maleic anhydride-maleic acid half ester copolymer, and the salts thereof.

The weight-average molecular weight of the resin dispersant is preferably 2,000 to 50,000, more preferably, 5,000 to 25,000, and particularly preferably 3,000 to 15,000. When a resin dispersant whose weight-average molecular weight is out of the range described above is used, the dispersion stability of particles in the ink tends to decrease.

The acid value of the resin dispersant is preferably 80 mgKOH/g or more, and more preferably 100 mgKOH/g or more. When the acid value of the resin dispersant is less than 80 mgKOH/g, the ejection stability of the ink tends to decrease. Furthermore, the acid value of the resin dispersant is preferably 250 mgKOH/g or less, and more preferably 200 mgKOH/g or less. When the acid value of the resin dispersant is more than 250 mgKOH/g, the resin dispersant is unlikely to adsorb to the compound represented by general formula (I), and the dispersion stability of particles tends to decrease.

As the resin dispersant, a polyacrylic dispersant or a styrene acrylic dispersant can be used, and more particularly, a styrene-acrylic acid copolymer can be used. As the polyacrylic dispersant, a product prepared by a known polymerization method may be used, or a commercially available product may be used.

Examples of a commercially available polyacrylic dispersant include JONCRYL (registered trademark) series (trade name, manufactured by BASF Japan Ltd.) and the like. Specific examples of JONCRYL series include, in terms of trade name, JONCRYL 67 (weight-average molecular weight 12,500, acid value 213 mgKOH/g), JONCRYL 678 (weight-average molecular weight 8,500, acid value 215 mgKOH/g), JONCRYL 586 (weight-average molecular weight 4,600, acid value 108 mgKOH/g), JONCRYL 680 (weight-average molecular weight 4,900, acid value 215 mgKOH/g), JONCRYL 682 (weight-average molecular weight 1,700, acid value 238 mgKOH/g), JONCRYL 683 (weight-average molecular weight 8,000, acid value 160 mgKOH/g), JONCRYL 690 (weight-average molecular weight 16,500, acid value 240 mgKOH/g), JONCRYL 819 (weight-average molecular weight 14,500, acid value 75 mgKOH/g), JONCRYL JDX-C3000 (weight-average molecular weight 10,000, acid value 85 mgKOH/g), and JONCRYL JDX-C3080 (weight-average molecular weight 14,000, acid value 230 mgKOH/g).

The JONCRYL series are each a copolymer of (meth)acrylic acid and at least one of a (meth)acrylic acid alkyl ester and a styrene-based monomer. Furthermore, JONCRYL JDX-C3000 is a copolymer of (meth)acrylic acid and a (meth)acrylic acid alkyl ester. Note that the weight-average molecular weight and the acid value of the JONCRYL series described above are catalog values.

The content of the low-molecular-weight dispersant or the resin dispersant in the ink is preferably 10% by mass or more, more preferably 20% by mass or more, and particularly preferably 30% by mass or more, relative to the compound represented by general formula (I). When the content of the dispersant is less than 10% by mass relative to the compound represented by general formula (I), the dispersion stability of particles tends to decrease. Furthermore, the content of the dispersant in the ink is preferably 1,000% by mass or less, more preferably 500% by mass or less, and particularly preferably 200% by mass or less, relative to the compound represented by general formula (I). When the content of the dispersant is more than 1,000% by mass relative to the compound represented by general formula (I), the metallic luster of an image to be recorded tends to be impaired.

### Method for Producing Particles of Compound Represented by General Formula (I)

In the present invention, the compound represented by general formula (I) is dispersed in the form of particles in the ink. There are two methods for producing particles of the compound represented by general formula (I), namely, a top-down method and a bottom-up method. The top-down method is a method in which coarse particles are mechanically disintegrated and pulverized using a disperser, such as a roll mill or a bead mill. The bottom-up method is a method in which particles are precipitated from a solution in which a target compound is dissolved. As the particles of the compound represented by general formula (I), particles produced by either method can be suitably used. From the standpoint that particles with a small particle size can be easily produced, production by the bottom-up method can be employed. As the bottom-up method, an in-liquid drying method, a dissolution-reprecipitation method, a phase inversion emulsification method, and the like are known, and any of these methods can be used.

In an in-liquid drying method, a solution in which the compound represented by general formula (I) is dissolved in a water insoluble or poorly soluble organic solvent is mixed with water in the presence of a dispersant. By removing the organic solvent from the resulting emulsion, particles of the compound represented by general formula (I) are precipitated in water. In a dissolution-reprecipitation method, a solution in which the compound represented by general formula (I) is dissolved in an organic solvent (hereinafter described as the “compound solution”) and a solvent that is scarcely capable of dissolving the compound or water are mixed in the presence of a dispersant. Thereby, particles of the compound are precipitated again in water or the like. In these bottom-up production methods, particles of the compound represented by general formula (I) can be produced under mild conditions.

A method of preparing particles used for the ink of the present invention will be described on the basis of an example. First, a first liquid which contains a compound represented by general formula (I) and an organic solvent and a second liquid which contains water and a dispersant are prepared. The prepared first and second liquids are mixed to obtain an emulsion which contains the first liquid as a dispersoid. The dispersoid contains the compound represented by general formula (I) and the organic solvent and is dispersed in water by the dispersant. Subsequently, by removing the organic solvent from the dispersoid, it is possible to obtain particles which are dispersion-stabilized in water by the dispersant.

The compound represented by general formula (I) in the first liquid can be dissolved in the organic solvent. Furthermore, the dispersant in the second liquid can be dissolved in water. Furthermore, before or after mixing of the first liquid and the second liquid, optionally, the pH of the first liquid, the second liquid, or the mixture thereof (emulsion) can be adjusted to near neutral (pH 6 to 10). Thereby, the dispersant becomes likely to adsorb to the compound represented by general formula (I), and it is possible to obtain particles which are further dispersion-stabilized.

When the first liquid and the second liquid are mixed, for example, a known stirring/shearing device that imparts mechanical energy to the mixing process, such as a high-shear homomixer, an ultrasonic homogenizer, a high-pressure homogenizer, or a thin-film high-speed rotating mixer, is used. In particular, an ultrasonic homogenizer, a high-pressure homogenizer, or a thin-film high-speed rotating mixer can be used. Furthermore, an emulsion may be prepared by a membrane emulsification method that uses an SPG membrane or a microchannel emulsification method, a microchannel-branched emulsification method, or the like which uses a microreactor or the like based on an interfacial chemical mechanism. The emulsion may be prepared in a single stage or multiple stages. Furthermore, the mass ratio of the first liquid to the second liquid (first liquid/second liquid) is set preferably at 1/20 to ⅔, and more preferably at 1/15 to ½.

From the viewpoint of throughput, the organic solvent can be removed from the dispersoid by a pressure reduction operation, a dialysis operation, or both. The pressure reduction operation can be carried out using a known pressure-reducing device, such as an evaporator. Furthermore, the dialysis operation can be carried out, for example, using a known dialyzer, such as an ultrafiltration device, in addition to a static dialysis method using a semipermeable membrane.

The organic solvent used in the first liquid can be an organic solvent that has low solubility in water and is capable of forming an interface when mixed with water. The solubility of the organic solvent is preferably 3 parts by mass or less relative to 97 parts by mass of water at 25° C. When an organic solvent whose solubility relative to 97 parts by mass of water at 25° C. is 3 parts by mass or less is used, it is possible to prepare an emulsion in good condition. When an organic solvent having a lower boiling point than that of water is used, the organic solvent can be easily removed from the dispersoid in the emulsion. Specific examples of such an organic solvent include halogenated hydrocarbons, such as dichloromethane, chloroform, chloroethane, dichloroethane, trichloroethane, and carbon tetrachloride; ketones, such as acetone, methyl ethyl ketone, and methyl isobutyl ketone; ethers, such as tetrahydrofuran, ethyl ether, and isobutyl ether; esters, such as ethyl acetate and butyl acetate; and aromatic hydrocarbons, such as benzene, toluene, and xylene.

In the case where a resin dispersant is used, in order to dissolve the resin dispersant in the ink, using a basic compound, a salt can be formed between an anionic group (e.g., an acidic group such as a carboxyl group) in the resin dispersant and a counter-cation. The basic compound is not particularly limited as long as it is a compound capable of forming a salt with an anionic group such as a carboxyl group. Specific examples of the basic compound include organic amines, such as primary amines, secondary amines, tertiary amines, and quaternary ammonium salt; amino alcohol compounds, such as aminomethyl propanol, 2-amino isopropanol, and triethanolamine; cyclic amines, such as morpholine; and inorganic bases, such as ammonia water. The amount of the basic compound is preferably equal to or more than the neutralization equivalent of the resin dispersant. Furthermore, from the viewpoint of image fixability, the amount of the basic compound is more preferably about 1.3 times the neutralization equivalent of the resin dispersant.

Furthermore, in order to facilitate ionic dissociation of the resin dispersant salt, a pH buffer solution can be added to the ink to adjust the pH of the ink, thereby enhancing the dissolution stability of the resin dispersant. The pH buffer solution is not particularly limited as long as it can control the pH of the ink to 6.5 to 10. Specific examples of a salt used as the pH buffer solution include potassium hydrogen phthalate, potassium dihydrogenphosphate, sodium dihydrogenphosphate, sodium tetraborate, potassium hydrogen tartrate, sodium hydrogencarbonate, sodium carbonate, tris(hydroxymethyl)aminomethane, and tris(hydroxymethyl)aminomethane hydrochloride. The content of the pH buffer solution in the ink is preferably set such that the pH of the ink is 6.5 to 10 from the standpoint of the durability of recording head members and the stability of the ink.

### Solvent

Since the ink of the present invention is an aqueous ink, the ink contains water as a solvent. The content (% by mass) of water in the ink is preferably 30% by mass or more, more preferably 40% by mass or more, and particularly preferably 50% by mass or more, relative to the total mass of the ink. When the content of water is less than 30% by mass, the viscosity of the ink increases, and continuous ejection stability tends to decrease. Furthermore, the content of water in the ink is preferably 95% by mass or less, and more preferably 90% by mass or less, relative to the total mass of the ink. When the content of water is more than 95% by mass, the amount of the evaporation component in the ink increases excessively, and fixing tends to occur in nozzles of an inkjet head.

Furthermore, the ink of the present invention may contain a water-soluble organic solvent. As the water-soluble organic solvent, any known water-soluble organic solvent commonly used for inks for inkjet use can be used. Specific examples of the water-soluble organic solvent include monohydric or polyhydric alcohols, alkylene glycols having about 1 to 4 carbon atoms, polyethylene glycols having a number-average molecular weight of about 200 to 2,000, glycol ethers, and nitrogen-containing compounds. The content (% by mass) of the water-soluble organic solvent in the ink is preferably 1.0% by mass to 40.0% by mass, and more preferably 3.0% by mass to 30.0% by mass, relative to the total mass of the ink.

### Other Components

In addition to the components described above, organic compounds that are in a solid state at ambient temperature, such as trimethylolethane and trimethylolpropane; and nitrogen-containing compounds, such as urea and ethyleneurea, may be optionally incorporated into the ink of the present invention. Furthermore, in addition to the components described above, various additives, such as a surfactant, a pH adjuster, an antifoaming agent, an antirust, a preservative, a fungicide, an oxidation inhibitor, a reduction inhibitor, an evaporation accelerator, a chelating agent, and a water-soluble resin, may be optionally incorporated into the ink.

### Physical Properties of Ink

The pH of the ink of the present invention is preferably 6.5 or more from the standpoint of maintaining storage stability and dispersion stability of particles. In the case where a resin dispersant is used as the dispersant, the pH of the ink is preferably equal to or more than the isoelectric point of the resin dispersant. The surface tension of the ink of the present invention is preferably 20 to 40 mN/m, and more preferably 25 to 40 mN/m, from the standpoint of improving ejection stability from an inkjet head. Furthermore, the viscosity of the ink of the present invention is preferably 15 mPa·s or less, more preferably 10 mPa·s or less, and particularly preferably 5 mPa·s or less.

### Inkjet Recording Method

In an inkjet recording method, the ink of the present invention described above is ejected from a recording head used in an inkjet method to record an image on a recording medium. Examples of the ink ejecting method include a method in which the ink is ejected from a recording head by the action of mechanical energy and a method in which the ink is ejected from a recording head by the action of thermal energy. In particular, a method in which the ink is ejected from a recording head by the action of thermal energy can be employed. Except for the use of the ink of the present invention, known processes may be used in the inkjet recording method. Furthermore, examples of the recording medium include permeable recording media, such as plain paper and glossy paper, and non-permeable recording media, such as films.

In an image formed using the ink of the present invention, although regular reflection light from the image with respect to incident light (reflected light that is reflected by the specular surface at an angle of reflection that is the same as the angle of incidence of incident light) has a golden color, diffusion light that is reflected at an angle different from that of regular reflection light may have a hue different from the golden color, in some cases resulting in a decrease in the sensation of golden color. In such cases, prior to the step of applying the ink of the present invention, by providing a step of forming a base of black color or a color opposite to that of diffusion light of the ink on the recording medium, diffusion light from the image can be reduced, and accordingly, the sensation of golden color can be improved.

The base of black color or a color opposite to that of diffusion light of the ink can be formed by applying a black ink or an ink having a color opposite to that of diffusion light of the ink of the present invention to the recording medium.

The term “black color” means that, when a solid image sample is printed at a duty of 100% on a recording medium, the image sample has absorption in all the light wavelength region of 380 to 780 nm. Furthermore, in the case where color measurement is performed on the image sample by a colorimetric method using an integrating sphere-type spectrocolorimeter with a regular reflection light component excluded, under a light source D50 (on the basis of the measurement principles determined by the international standard ISO7724/1, measurement is performed in accordance with the method described in the condition c of JIS Z 8722; and note that such a measurement method also conforms to the object color measurement method specified in the International Commission on Illumination, CIE No. 15 and ASTM E1164 standardized by the American Society for Testing and Materials), in the CIEL*a*b* colorimetric system, the lightness L* is preferably 35 or less, more preferably 25 or less, and particularly preferably 15 or less. When the lightness L* is 35 or less, diffusion light can be sufficiently reduced, and it is possible to obtain an image in which the sensation of golden color is improved.

Furthermore, in the present invention, in the case where an ink having a color opposite to that of diffusion light of the ink of the present invention is used as an ink for forming the base, the ink for forming the base can contain a color material that produces a color opposite to that of diffusion light of the ink of the present invention. In the present invention, the term “diffusion light” is defined as a light component excluding a regular reflection light (specular light) component from reflected light with respect to incident light incident at a specific angle of incidence on an image. Color measurement on diffusion light can be performed, for example, in the wavelength region of 380 to 780 nm, by a colorimetric method using an integrating sphere-type spectrocolorimeter with a regular reflection light component excluded, under a light source D50. The term “opposite color” means a hue satisfying the expression (1) below

Hue angle of diffusion light of the ink+162°≦hue angle of diffusion light of the opposite color Hue angle of diffusion light of the ink+198° Expression (1):

The ink having an opposite color can be an ink having a color that is complementary to the color of diffusion light of the ink with respect to the metallic ink chromaticity (values a* and b*) in the CIEL*a*b* colorimetric system.

Furthermore, in the present invention, the values a* and b* of the opposite color in the CIEL*a*b* colorimetric system (a₂* and b₂*) and the values a* and b* of the ink (a₁* and b₁*) can satisfy the following formula:

|{(a₁*)²+(b₁*)²}^{1/2}−{(a₂*)²+(b₂*)²}^{1/2}|≦30

The left part of the above formula indicates the difference in distance from the origin (a*=0, b*=0) of the a*b* plane in the CIEL*a*b* colorimetric system. As the difference decreases, i.e., becomes closer to 0, the diffusion light reduction effect by the opposite color increases, and thus a more desirable golden color image can be obtained.

Furthermore, in order to further improve the sensation of golden color of the image formed using the ink of the present invention, a black ink can be used as the ink for forming the base. The black ink can be an ink which contains a pigment or dye that has absorption in all the wavelength region of 380 to 780 nm. As the usable pigment or dye, any of black pigments or black dyes commonly used for inks for inkjet use can be selected, and these can be used alone or in combination of two or more. As the black ink, a commercially available black dye ink or black pigment ink can be used.

Diffusion light of an image formed on a recording medium using the ink of the present invention and the ink for forming the base can be measured by a spectrocolorimeter (trade name: CM-2600d, manufactured by Konica Minolta) in a mode excluding a regular reflection light component (SCE mode). When color measurement is performed by a colorimetric method using an integrating sphere-type spectrocolorimeter with a regular reflection light component excluded, regarding light source environmental conditions, a light source D50 (stipulated in JIS Z 8720:2012) which is suitable for color measurement of prints can be used in the present invention. The light source used in the color measurement is not limited to the light source D50, and a light source A, a light source C, or a light source D65 (stipulated in JIS Z 8720:2012) may also be used. In addition, a light source F2, a light source F6, a light source F7, a light source F8, a light source F10, or a light source F12 can be used. A suitable light source can be appropriately used depending on recording conditions/environment. In the case where a black ink is used as the ink for forming the base, the same advantageous effect can be obtained using any of the light sources.

In the present invention, the thickness of a layer of the ink for forming the base on the recording medium is preferably 0.001 μm or more, more preferably 0.01 μm or more, and still more preferably 0.05 μm or more. Furthermore, the thickness is preferably 10 μm or less, more preferably 5 μm or less, and still more preferably 1 μm or less. The thickness measurement method is not particularly limited as long as the thickness of a thin film having a thickness on the order of micrometer can be measured. For example, a method may be used in which a cross section of an image is taken, the cross section is observed with a scanning electron microscope, and the thickness is measured.

Ink to which Black Dye is Added

By adding a black dye to the ink of the present invention, diffusion light of the image can be reduced as in the case of the black base layer described above, and accordingly, the sensation of golden color can be improved. As the usable black dye, any of dyes commonly used for inks for inkjet use can be selected, and these can be used alone or in combination of two or more. Alternatively, instead of the black dye, a commercially available black dye ink may be used.

### EXAMPLES

The present invention will be described below in more detail on the basis of examples and comparative examples, but it is to be understood that the invention is not limited to the examples within a scope that does not depart from the gist of the present invention. Regarding the contents, “parts” and “%” are on a mass basis unless otherwise indicated. Furthermore, the average particle size of particles means the volume-average particle size at a cumulative value of 50% in the particle size distribution measured using a dynamic light scattering particle size/particle size distribution measuring apparatus (trade name “Nanotrac UPA 150EX” manufactured by Nikkiso Co., Ltd).

### Synthesis of Compound 3

10.0 Parts of 1,4-bis(bromomethyl)benzene, 12.8 parts of diphenylamine, 17.8 parts of sodium carbonate, and 100 parts of N,N-dimethylformamide were mixed and stirred at 100° C. for 7 hours to allow a reaction to take place. Then, diisopropylamine (20 parts) was added thereto, and an intermediate A (solid) represented by formula (A) below was obtained by filtration.

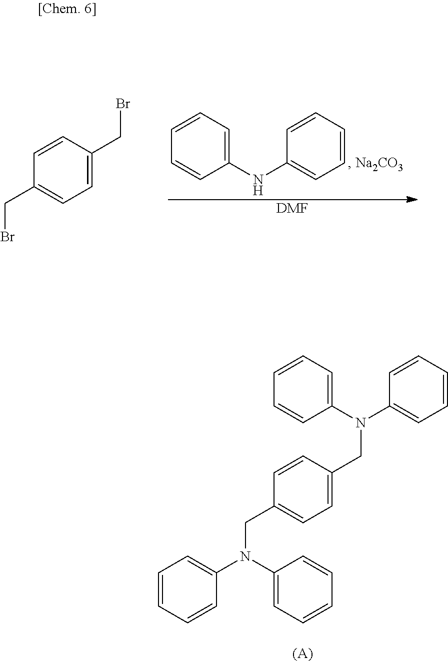

After 4.8 parts of the intermediate A was dissolved in 30 parts of N,N-dimethylformamide, 3.5 parts of tetracyanoethylene was added thereto, and the mixture was stirred at 70° C. for 1.5 hours to allow a reaction to take place. The reaction mixture was added into water, and extraction was performed with diethyl ether. After the solvent was distilled off under reduced pressure, the resulting solid was recrystallized using chloroform to give a compound 3 represented by formula (3) below. The maximum absorption wavelength Amax of the resulting compound, when dissolved in chloroform, was measured, using a UV-VIS-NIR spectrophotometer UV-3600 (Shimadzu Corporation), to be 502 nm.

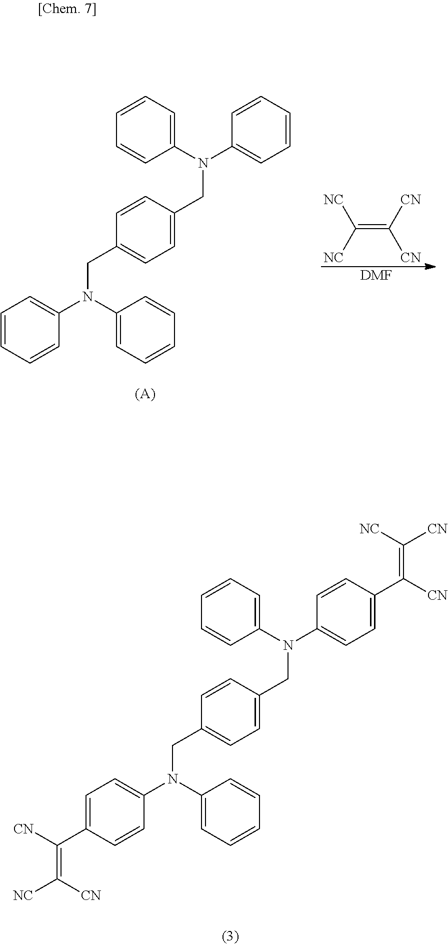

### Synthesis of Compound 7

After 5.0 parts of N-methyl-N-phenylaniline was dissolved in 30 parts of N,N-dimethylformamide, 5.2 parts of tetracyanoethylene was added thereto, and the mixture was stirred at room temperature for 1.5 hours to allow a reaction to take place. The reaction mixture was added into water, and extraction was performed with diethyl ether. After the solvent was distilled off under reduced pressure, the resulting solid was recrystallized using a mixed solvent of ethyl acetate and hexane to give a compound 7. The maximum absorption wavelength λmax of the resulting compound, when dissolved in chloroform, was measured, using a UV-VIS-NIR spectrophotometer UV-3600 (Shimadzu Corporation), to be 514 nm.

### Example 1: Ink 1

### Preparation of Dispersion 1

A mixed liquid was prepared by dissolving 3 parts of the compound 3 in 200 parts of chloroform. On the other hand, an aqueous solution of KOH was added to a mixture of 5 parts of a styrene-acrylic acid copolymer (weight-average molecular weight: 12,000, acid value: 170 mgKOH/g) and 500 parts of water to adjust the pH to 10. An aqueous solution of the resin dispersant was thus prepared. The mixed liquid was added to the prepared aqueous solution of the resin dispersant, and emulsification was performed, under ice-cooling, for 15 minutes using an ultrasonic homogenizer, to obtain an emulsion. Chloroform was distilled off under reduced pressure using an evaporator. Thereby, a dispersion 1 was obtained. The average particle size of particles in the resulting dispersion 1 was 88 nm.

### Preparation of Ink 1

The components described below (total: 100 parts) and the dispersion 1 were mixed such that the concentration of the solid content (total of the compound 3 and the dispersant) in the ink was 5%. Pressure filtration was performed using a membrane filter with a pore size of 2.5 μm, and an ink 1 was obtained. The average particle size of particles in the ink 1 was 90 nm.

| Glycerol | 10.0 | parts |
|---|---|---|
| Acetylenol EH | 1.0 | part |
| (manufactured | | |
| by Kawaken Fine | | |
| Chemicals | | |
| Co., Ltd.) | | |
| Ion-exchanged water | 89.0 | parts |

### Example 2: Ink 2

### Preparation of Dispersion 2

A mixed liquid was obtained by dissolving 1 part of the compound 3 in 70 parts of chloroform. A mixture of 5 parts of sodium dodecyl sulfate and 180 parts of water was added to the mixed liquid, and emulsification was performed, under ice-cooling, for 15 minutes using an ultrasonic homogenizer, to obtain an emulsion. Chloroform was distilled off under reduced pressure using an evaporator. Thereby, a dispersion 2 was obtained. The average particle size of particles in the resulting dispersion 2 was 18 nm.

### Preparation of Ink 2

An ink 2 was obtained as in the preparation of the ink 1 except that the dispersion 2 was used instead of the dispersion 1. The average particle size of particles in the ink 2 was 17 nm.

### Example 3: Ink 3

### Preparation of Dispersion 3

A mixed liquid was obtained by dissolving 0.5 parts of the compound 7 in 20 parts of chloroform. On the other hand, an aqueous solution of KOH was added to a mixture of 0.5 parts of a styrene-acrylic acid copolymer (weight-average molecular weight: 12,000, acid value: 170 mgKOH/g) and 50 parts of water to adjust the pH to 10. An aqueous solution of the resin dispersant was thus prepared. The mixed liquid was added to the prepared aqueous solution of the resin dispersant, and emulsification was performed, under ice-cooling, for 15 minutes using an ultrasonic homogenizer, to obtain an emulsion. Chloroform was distilled off under reduced pressure using an evaporator. Thereby, a dispersion 3 was obtained. The average particle size of particles in the resulting dispersion 3 was 350 nm.

### Preparation of Ink 3

An ink 3 was obtained as in the preparation of the ink 1 except that the dispersion 3 was used instead of the dispersion 1. The average particle size of particles in the ink 3 was 250 nm.

### Preparation of Ink 4

The components described below (total: 100 parts) and the dispersion 1 were mixed such that the concentration of the solid content in the ink was 5%. Pressure filtration was performed using a membrane filter with a pore size of 2.5 μm, and an ink 4 was obtained.

| | | |
|---|---|---|
| BCI-7eBk black dye ink | 35.0 | parts |
| (manufactured by CANON | | |
| KABUSHIKI KAISHA) | | |
| Glycerol | 10.0 | parts |
| Acetylenol EH | 1.0 | part |
| (manufactured | | |
| by Kawaken | | |
| Fine Chemicals | | |
| Co., Ltd.) | | |

| | |
|---|---|
| Ion-exchanged water | Balance |

### Image Recording-1

An inkjet recording apparatus (trade name “F930”, manufactured by CANON KABUSHIKI KAISHA; recording head: 6 ejection opening rows (each having 512 nozzles); amount of ink: 4.0 pL (fixed amount); resolution: max. 1,200 dpi (width)×1,200 dpi (length)) was prepared. Each of the prepared inks 1 to 3 was charged into the inkjet recording apparatus, and a solid image of 1 cm×1 cm was printed on inkjet photo paper (trade name “Canon glossy photo paper pro PR-201” manufactured by CANON KABUSHIKI KAISHA). When visually observed, the portion printed with the ink 1 and the portion printed with the ink 2 each produced a golden color image. The portion printed with the ink 3 produced a slightly greenish-golden color image. The recorded images were left to stand for three months, and no changes were observed to have occurred in any of the images.

Furthermore, both the image formed using the ink 1 and the image formed using the ink 2 had a uniform golden color, and both the inks 1 and 2 had good ejection stability. On the other hand, some white spots were observed in the image formed using the ink 3, and the ejection stability of the ink 3 was lower than that of the inks 1 and 2. Furthermore, the prepared inks were left to stand for one month, and no changes in particle size were observed to have occurred in any of the inks.

### Image Recording-2

Image formation was performed using an F930 (manufactured by CANON KABUSHIKI KAISHA; recording head: 6 ejection opening rows (each having 512 nozzles); amount of ink: 4.0 pl (fixed amount); resolution: max. 1,200 dpi (width)×1,200 dpi (length)). Each of a commercially available BCI-7eBk black dye ink (manufactured by CANON KABUSHIKI KAISHA) and the inks 1 to 3 was charged into an ink cartridge of the F930. Then, the black ink was printed on inkjet photo paper (Canon glossy photo paper pro PR-201), i.e., a recording medium, so as to form a solid image of 3 cm×3 cm. Subsequently, using the inks 1 to 3, a solid image of 3 cm×3 cm was printed on the region in which the black ink had been printed. When the printed portion was visually observed, diffusion light having different colors was reduced, and the image had a higher sensation of golden color than the image formed in the image recording-1.

### Image Recording-3

Using the ink 4, a solid image was printed in the same manner as that in the image recording-1. When the printed portion was visually observed, the image had a high sensation of golden color as in the image recording-2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-077756 filed Apr. 4, 2014 and No. 2015-042691 filed Mar. 4, 2015, which are hereby incorporated by reference herein in their entirety.

1. An aqueous ink for inkjet use comprising:
particles of a compound represented by general formula (I); and
a dispersant that disperses the particles: 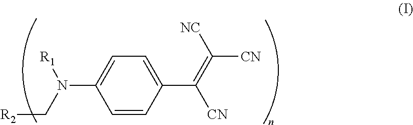
wherein R₁ represents an aromatic ring; R₂ represents a hydrogen atom, an alkyl group, or a benzene ring; when R₂ is a hydrogen atom or an alkyl group, n is 1; and when R₂ is a benzene ring, n is an integer of any one of 1 to 3.

2. The aqueous ink for inkjet use according to claim 1, wherein, in the compound represented by general formula (I), R₁ and R₂ are each a benzene ring, and n is 2 or 3.

3. The aqueous ink for inkjet use according to claim 1, wherein the compound represented by general formula (I) is a compound represented by general formula (II):

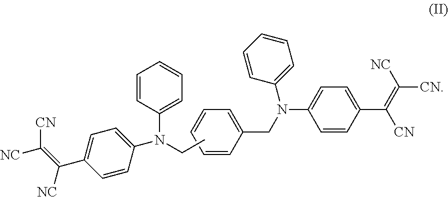

4. The aqueous ink for inkjet use according to claim 1, wherein the dispersant is a resin dispersant having an anionic group or an anionic surfactant.

5. An inkjet recording method comprising ejecting an aqueous ink from a recording head by the action of thermal energy, wherein the aqueous ink comprises:
particles of a compound represented by general formula (I); and
a dispersant that disperses the particles: 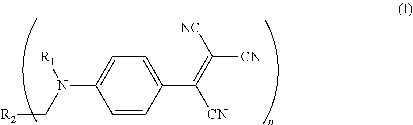
wherein R₁ represents an aromatic ring; R₂ represents a hydrogen atom, an alkyl group, or a benzene ring; when R₂ is a hydrogen atom or an alkyl group, n is 1; and when R₂ is a benzene ring, n is an integer of an one of 1 to 3.

6. The aqueous ink for inkjet use according to claim 1, wherein the particles are formed by a method in which after the compound represented by general formula (I) is dissolved in an organic solvent, the particles are precipitated in water.
